(19) United States
(12) Patent Application Publication
(10) Pub. No.: US 2024/0372375 A1
(43) Pub. Date: Nov. 7, 2024

(54) ELECTRONIC DEVICE FOR DETECTING SUBMERGENCE AND METHOD FOR OPERATING SAME

(71) Applicant: SAMSUNG ELECTRONICS CO., LTD., Suwon-si (KR)

(72) Inventors: Dalsung KIM, Suwon-si (KR); Munki SEOK, Suwon-si (KR); Seungho LEE, Suwon-si (KR)

(21) Appl. No.: 18/778,264

(22) Filed: Jul. 19, 2024

Related U.S. Application Data
(63) Continuation of application No. PCT/KR2022/020490, filed on Dec. 15, 2022.

(30) Foreign Application Priority Data
Jan. 21, 2022 (KR) 10-2022-0009416
Feb. 18, 2022 (KR) 10-2022-0021654

(51) Int. Cl. H02J 7/00

(52) U.S. Cl. CPC H02J 7/00043; H02J 7/00041; H02J 7/0036; H02J 7/0044

(57) ABSTRACT

According to various embodiments, an electronic device including a housing and a detection circuit configured to output a signal indicating a submerged state on the basis of a condition associated with submergence being satisfied is provided. The electronic device also includes a plurality of terminals, a switching circuit electrically connected to the plurality of terminals, and a processor. The processor is configured to: receive the signal output from the detection circuit while the switching circuit is in a first state and output a control signal, for switching the state of the switching circuit from the first state to a second state, to the switching circuit on the basis of the received signal. The switching circuit can be configured to switch from the first state to the second state on the basis of the reception of the control signal.

### CROSS-REFERENCE TO RELATED APPLICATION(S)

This application is a continuation application, claiming priority under § 365 (c), of International Application No. PCT/KR2022/020490 filed on Dec. 15, 2022, which is based on and claims the benefit of Korean patent application number 10-2022-0009416 filed on Jan. 21, 2022, in the Korean Intellectual Property Office and of Korean patent application number 10-2022-0021654 filed on Feb. 18, 2022, in the Korean Intellectual Property Office, the disclosures of which are incorporated by reference herein in their entireties.

### BACKGROUND

Various embodiments of the disclosure relate to submergence of an electronic device and a method for operating the same.

With the development of electronic communication technologies, electronic devices have become more compact and lightweight to be worn on the user's body without discomfort. For example, commercially available wearable electronic devices include true wireless stereos (TWS) devices, smart watches (or bands), contact lens-type devices, ring-type devices, glove-type devices, shoe-type devices, or clothing-type devices. As directly worn on a body part, the wearable electronic device may be downsized to provide enhanced portability, but may be submerged by the user's carelessness.

The wearable electronic device or portable terminal may include a submergence check label, rendering it possible to identify whether moisture has been introduced thereinto by disassembling the electronic device and checking the submergence check label. In other words, although the printed board assembly (PBA) is damaged due to moisture introduced into the electronic device, it may be difficult to identify whether moisture is introduced into the electronic device before disassembling the electronic device.

Meanwhile, an electronic device including a display has the functions of detecting moisture on the micro USB pins and, if moisture is detected, providing a notification to the user through the display while blocking charging of the electronic device. However, the electronic device does not detect the introduction of moisture into the electronic device. Although a wearable electronic device without a display may be configured to detect moisture being introduced thereinto, it is not configured to provide a notification of the detection of the introduction of water to the user.

### SUMMARY

As described above, when moisture is introduced into the electronic device, particularly when charging power is applied with moisture introduced thereinto, it is likely to damage the PBA. Accordingly, it is required to detect introduction of moisture into the electronic device and provide a notification for moisture introduction to the user.

An electronic device and a method for operating the same according to various embodiments may change electrical characteristics between terminals based on detection of submergence and may detect introduction of moisture inside and accordingly provide a notification to the user even when the electronic device is not disassembled.

According to various embodiments, an electronic device may include a housing, a detection circuit disposed inside the housing, and configured to output a signal indicating a flooding state based on a condition associated with flooding being satisfied, a plurality of terminals exposed to an outside of the housing through a plurality of openings formed in the housing, a switching circuit electrically connected to the plurality of terminals, at least one processor including processing circuitry, and memory comprising one or more storage media storing instructions. The instructions, when executed by the at least one processor individually or collectively, cause the electronic device to receive the signal output from the detection circuit while a state of the switching circuit is a first state, and output, to the switching circuit, a control signal for switching the state of the switching circuit from the first state to a second state based on the received signal. The switching circuit may be configured to switch from the first state to the second state based on reception of the control signal.

According to various embodiments, a method for operating an electronic device may include receiving a signal indicating a flooding state from a detection circuit based on a condition associated with flooding being satisfied while a state of a switching circuit electrically connected to a plurality of terminals exposed to an outside of a housing of the electronic device through a plurality of openings formed in the housing is a first state, wherein an electrical characteristic between the plurality of terminals is a first characteristic while the state of the switching circuit is the first state, and outputting, to the switching circuit, a control signal for switching the state of the switching circuit from the first state to a second state based on the received signal, wherein the electrical characteristic between the plurality of terminals is a second characteristic while the state of the switching circuit is the second state. The switching circuit is configured to switch from the first state to the second state based on reception of the control signal.

According to various embodiments, a charger may include a power charging circuit configured to output a signal indicating a flooding state of an electronic device based on an electrical characteristic between a plurality of terminals in a state of being electrically connected to the plurality of terminals of the electronic device, a charging indication circuit, and a processor operatively connected with the power charging circuit and the charging indication circuit. The processor may be configured to receive the signal output from the power charging circuit while an indication state of the charging indication circuit is a first indication state and output, to the charging indication circuit, a control signal for switching the indication state of the charging indication circuit from the first indication state to a second indication state based on the received signal. The second indication state may differ from the first indication state. The charging indication circuit may be configured to switch from the first indication state to the second indication state based on the reception of the control signal.

According to various embodiments, it is possible to change the electrical characteristics between terminals based on the detection of flooding. It is also possible to prevent damage to internal components as the electronic device is disassembled by detecting introduction of moisture inside and accordingly providing a notification to the user even without disassembling the electronic device.

It is also possible to prevent damage to internal components due to introduction of moisture into an electronic device according to various embodiments.

### BRIEF DESCRIPTION OF THE DRAWINGS

FIG. 1 is a view illustrating an electronic device in a network environment according to various embodiments;

FIG. 2 is a flowchart illustrating operations of an electronic device according to various embodiments;

FIG. 3 is a block diagram illustrating a charger electrically connected with an electronic device according to various embodiments;

FIG. 4 is a flowchart illustrating operations of a charger according to various embodiments;

FIG. 5 illustrates an electronic device for describing a housing and a terminal of an electronic device according to various embodiments;

FIG. 6 is a block diagram illustrating an electronic device for describing signal transfer according to various embodiments;

FIG. 7A illustrates an electronic device for describing an arrangement of penetration holes and detection pins of an electronic device according to various embodiments;

FIG. 7B illustrates an electronic device in a disassembled state for describing an arrangement of penetration holes and detection pins of an electronic device according to various embodiments;

FIG. 8 is a flowchart illustrating operations of an electronic device according to various embodiments;

FIG. 9 illustrates a charger in a state of being electrically connected with an electronic device according to various embodiments;

FIG. 10 is a signal diagram of signal transfer between an electronic device and an external device according to various embodiments; and

FIG. 11 is a block diagram illustrating an external device in a network environment according to various embodiments.

### DETAILED DESCRIPTION

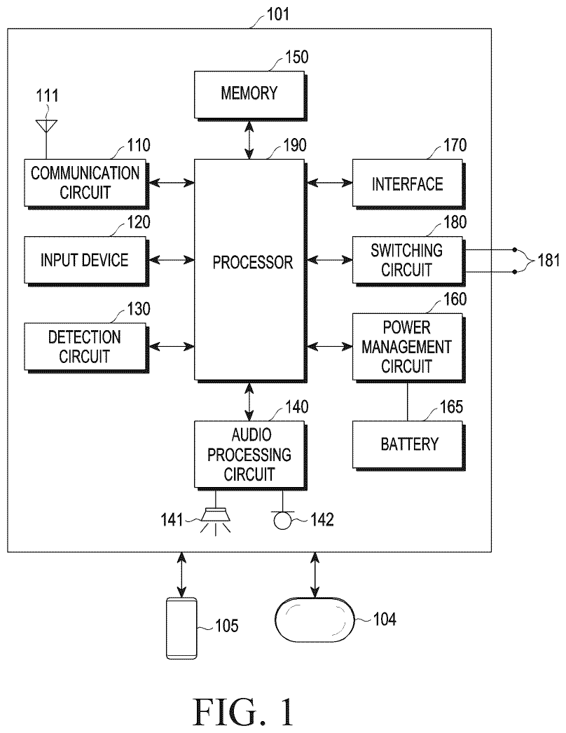

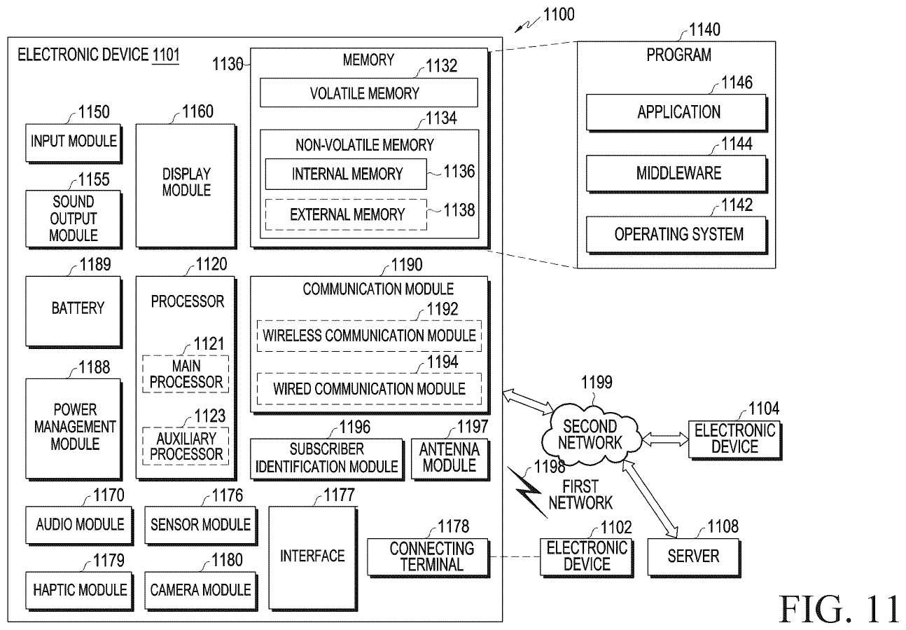

FIG. 1 is a block diagram illustrating an electronic device 101 in a network environment according to various embodiments. According to various embodiments, the electronic device 101 may be the electronic device 1101 of FIG. 11 described below. According to various embodiments, the electronic device 101 may be the external electronic device 1102 or the external electronic device 1104 of FIG. 11 described below. The electronic device 101 may include an antenna circuit 111 (e.g., the antenna module 1197 of FIG. 11), a communication circuit 110 (e.g., the communication module 1190 of FIG. 11), an input device 120 (e.g., the input module 1150 of FIG. 11), a detection circuit 130 (e.g., the sensor module 1176 of FIG. 11), an audio processing circuit 140 (e.g., the audio module 1170 of FIG. 11), memory 150 (e.g., the memory 1130 of FIG. 11), a power management circuit 160 (e.g., the power management module 1188 of FIG. 11), a battery 165 (e.g., the battery 1189 of FIG. 11), a switching circuit 180, an interface 170 (e.g., the interface 1177 of FIG. 11), and/or a processor 190 (e.g., the processor 1120 of FIG. 11).

The communication circuit 110 may include a wireless communication circuit (e.g., a cellular communication circuit, a wireless-fidelity (Wi-Fi) communication circuit, a Bluetooth communication circuit, a near-field communication (NFC) communication circuit, or a global navigation satellite system (GNSS) communication circuit) or a wired communication circuit (e.g., a local area network (LAN) communication circuit or a power line communication circuit). A corresponding communication circuit among these communication circuits may communicate with at least one of a first external electronic device 104 (e.g., a charger) or a second external electronic device 105 (e.g., a portable terminal) through a first network (e.g., the first network 1198 of FIG. 11) or a second network (e.g., the second network 1199 of FIG. 11). For example, the electronic device 101 may be an earbud. The communication circuit 110 may include one or more communication processors that are operable independently from the processor 190 and supports a direct (e.g., wired) communication or a wireless communication.

The antenna circuit 111 may transmit a signal or power to, or receive a signal or power from, another electronic device (e.g., the external electronic device 104 or 105 or the second electronic device 105). According to an embodiment, the antenna circuit 111 may include one antenna including a radiator formed of a conductor or conductive pattern formed on a substrate (e.g., a printed circuit board (PCB)). According to an embodiment, the antenna circuit 111 may include a plurality of antennas. In this case, at least one antenna appropriate for a communication scheme used in a communication network, such as the first network (e.g., the first network 1198 of FIG. 11) or the second network (e.g., the second network 1199 of FIG. 11), may be selected from the plurality of antennas by, e.g., the communication circuit 110. The signal or the power may then be transmitted or received between the communication circuit 110 and another electronic device via the selected at least one antenna. According to an embodiment, other parts (e.g., radio frequency integrated circuit (RFIC)) than the radiator may be further formed as part of the antenna circuit 111.

According to various embodiments, the antenna circuit 111 may include at least one of a coil, where current may be induced by a magnetic field, a resonator, where a resonance phenomenon is generated by a magnetic field having a specific resonant frequency, or a plurality of patch antennas for receiving electromagnetic waves, to wirelessly receive power from another electronic device (e.g., the external electronic device 104 or 105).

The detection circuit 130 may measure a physical quantity or detect an operational state of the electronic device 101. The detection circuit 130 may be configured to output a signal indicating a submergence state (or, a flooding state) of the electronic device 101 based on meeting a condition associated with submergence of the electronic device 101. The detection circuit 130 may detect moisture penetrating into the electronic device 101 and, if moisture is detected, determine that the condition associated with submergence is met and output a signal indicating submergence of the electronic device 101 to the processor 190. The detection circuit 130 may convert the detected information or processed determination into an electrical signal. The detection circuit 130 may have a configuration of varying in physical, chemical, or electrical characteristics when introduction of moisture occurs and detect the condition associated with submergence by detecting the varied characteristics. In an embodiment, the detection circuit 130 may be configured to cause a short circuit when moisture is introduced and accordingly detect a variation in electrical characteristics such as circuit voltage, current, or resistance.

The memory 150 may store various data used by at least one component (e.g., the processor 190 or the detection circuit 130) of the electronic device 101. The various data may include, for example, software and input data or output data for a command related thereto. The memory 150 may include a volatile memory or a non-volatile memory.

In an embodiment, the memory 150 may store a record of a signal indicating that the electronic device 101 is submerged, which is output from the detection circuit 130. Further, in one embodiment, the memory 150 may store a record in which the state is switched by a switching operation of the switching circuit 180, as will be described below.

The power management circuit 160 may manage power supplied to the electronic device 101. According to an embodiment, the power management circuit 160 may be implemented as at least part of, e.g., a power management integrated circuit (PMIC). According to an embodiment, the power management circuit 160 may include a battery charging module. According to an embodiment, when another electronic device (e.g., the external electronic device 104 or 105) is electrically connected (wirelessly or wiredly) with the electronic device 101, the power management circuit 160 may receive power from another electronic device to charge the battery 165.

According to an embodiment, the electronic device 101 may include a plurality of terminals 181 having end portions exposed to the outside, and the plurality of terminals 181 may be electrically connected to the power management circuit 160. The electrical connection between the plurality of terminals 181, the switching circuit 180, and the power management circuit 160 is described with reference to FIG. 6, for example.

The plurality of terminals 181 may be components contacting another electronic device (e.g., the external electronic device 104 or 105) and may contact a charging terminal installed in a mounting unit of the first external electronic device 104. The electronic device 101 may receive power through the plurality of terminals 181 contacting the charging terminal of the first external electronic device 104, and the power management circuit 160 may charge the battery 165 with the power received through the plurality of terminals 181.

According to an embodiment, when the electronic device 101 is inserted into the first external electronic device 104 in a state in which the electronic device 101 is powered off, the electronic device 101 may be powered on or turn on at least part of the communication circuit 110 based on the power supplied from the first external electronic device 104.

The battery 165 may supply power to at least one component of the electronic device 101. According to an embodiment, the battery 165 may include, for example, a primary cell which is not rechargeable, a secondary cell which is rechargeable, or a fuel cell. According to an embodiment, if the electronic device 101 is inserted into the first external electronic device 104, the electronic device 101 may charge the battery 165 to a previously designated charge level and then power on the electronic device 101 or turn on at least part of the communication circuit 110.

The switching circuit 180 may be electrically connected to the plurality of terminals 181 and the power management circuit 160. The state of the switching circuit 180 may be switched by a switching operation, and a resistance value between the plurality of terminals 181 may vary according to the switched state. In an embodiment, the switching circuit 180 may be connected to the plurality of terminals 181 in parallel with the power management circuit 160, and accordingly, when the state of the switching circuit 180 is switched, the resistance values measured at the plurality of terminals 181 may vary. The switching circuit 180 may include a switch performing a switching operation and a resistor. By the switching operation of the switch, the state may be switched between the state in which the resistor is connected to the plurality of terminals 181 or a cut-off state.

The interface 170 may support one or more specified protocols to be used for the electronic device 101 to be coupled with the external electronic device 104 or 105 directly (e.g., wiredly) or wirelessly. According to an embodiment, the interface 170 may include, for example, a high definition multimedia interface (HDMI), a universal serial bus (USB) interface, a secure digital (SD) card interface, or an audio interface. According to an embodiment, the interface 170 may include a plurality of terminals 181 for forming a physical connection with the first external electronic device 104.

According to various embodiments, the electronic device 101 may include a display device (not illustrated) (e.g., the display module 1160 of FIG. 11). The display device may be configured to provide various screen interfaces required for operation of the electronic device 101. As an embodiment, the display device may provide a user interface related to a submergence detection state. According to various embodiments, the display device may include a light emitting means such as a light emitting diode (LED). The display device may control the light emitting means to emit light of a specific color. For example, the display device may control the light emitting means to emit light of a first color (e.g., green) in a state in which submergence is not detected, or to emit light of a second color (e.g., red) in a state in which submergence is detected.

The processor 190 may execute, e.g., software to control at least one other component (e.g., a hardware or software component) of the electronic device 101 connected with the processor 190 and may process or compute various data. According to an embodiment, as at least part of the data processing or computation, the processor 190 may load a command or data received from another component (e.g., the detection circuit 130 or communication circuit 110) onto a volatile memory 150, process the command or the data stored in the volatile memory, and store resulting data in a non-volatile memory.

According to an embodiment, the processor 190 may identify whether an electrical connection is formed between the electronic device 101 and the first external electronic device 104 through the detection circuit 130 or the interface 170. According to an embodiment, the processor 190 may recognize a magnet installed in the first external electronic device 104 through a magnetic sensor (e.g., a hall sensor) included in the detection circuit 130, thereby identifying whether an electrical connection is formed between the electronic device 101 and the first external electronic device 104. According to an embodiment, the processor 190 may recognize that the connecting terminal included in the interface 170 contacts the connecting terminal installed in a mounting part of the first external electronic device 104, thus identifying whether an electrical connection is formed between the electronic device 101 and the first external electronic device 104.

According to various embodiments, the electronic device 101 may further include various circuits depending on the form in which it is provided. There are many variations according to the convergence trend of digital devices, so it is not possible to list them all, but components equivalent to the above-mentioned components may be further included in the electronic device 101. Further, it is apparent that in the electronic device 101 according to an embodiment, specific components may be excluded from the above components or replaced with other components according to the form in which it is provided. This will be easily understood by those of ordinary skill in the art.

According to various embodiments, a paired electronic device configured in pair with the electronic device 101 may include the same components as those included in the electronic device 101 and may perform all or some of the operations of the electronic device 101 described below in connection with the drawings.

According to various embodiments, operations described in the disclosure may be operations performed by the processor 190 of the electronic device 101 unless otherwise specified.

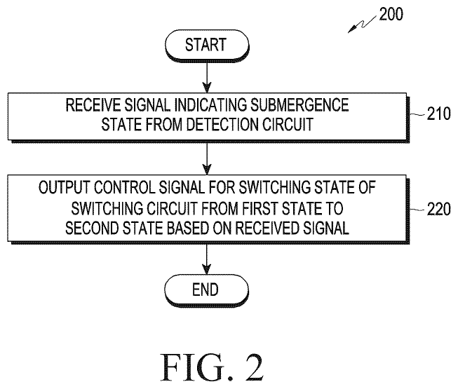

FIG. 2 is a flowchart 200 illustrating operations of an electronic device 101 according to various embodiments. According to various embodiments, in operation 210, the electronic device (e.g., the processor 190 of FIG. 1) may receive a signal indicating the submergence state from the detection circuit 130 of FIG. 1. For example, the detection circuit 130 of FIG. 1 may, continuously or based on an event, monitor a condition associated with submergence. The detection circuit 130 may be configured to output a signal indicating the submergence state when the condition associated with the submergence state is met as a result of monitoring. The processor 190 of FIG. 1 may receive the signal indicating the submergence state output from the detection circuit 130. For example, the processor 190 of FIG. 1 may receive the signal indicating the submergence state output from the detection circuit 130 while the switching circuit 180 is in the first state.

In exemplary embodiments, the condition associated with submergence is a condition for determining whether moisture has penetrated into the electronic device 101 by the detection circuit 130 of FIG. 1, and may be, e.g., a condition in which a circuit in an open state is electrically connected by moisture or a resistance value of the circuit is decreased, but those skilled in the art will understand that the type of the condition and the type of parameter used to determine whether the condition is met are not limited.

In exemplary embodiments, the signal indicating the submergence state may indicate, e.g., a state (Yes) in which it is detected that the electronic device 101 of FIG. 1 is submerged, or may indicate a state (No) in which it is detected that it is not submerged. According to another embodiment, the signal indicating the submergence state indicates a specific location at which moisture of the electronic device 101 has penetrated, and may be a signal including location information where moisture has penetrated. In exemplary embodiments, the switch from the first state to the second state may be, e.g., a switch from the off state of the switch included in the switching circuit 180 to the on state, or in another example, the switch from the on state of the switch included in the switching circuit 180 to the off state.

According to various embodiments, in operation 220, the electronic device (e.g., the processor 190 of FIG. 1) may output a control signal for switching the state of the switching circuit 180 of FIG. 1 from the first state to the second state, based on the signal indicating the submergence state received from the detection circuit 130 of FIG. 1.

According to various embodiments, the switching circuit 180 of FIG. 1 may be configured to switch from the first state to the second state, based on reception of a control signal for switching the state of the switching circuit 180 from the first state to the second state. As described above, the state of the switch included in the switching circuit 180 may be switched from the off state to the on state, and in another example, the state of the switch included in the switching circuit 180 may be switched from the on state to the off state. An electrical characteristic between the plurality of terminals 181 in the first state may be a first characteristic, and an electrical characteristic between the plurality of terminals 181 in the second state may be a second characteristic. Accordingly, based on the detection of the electrical characteristic between the plurality of terminals 181, it may be determined whether the terminal 181 is in a submergence state. For example, if the electrical characteristic between the plurality of terminals 181 is detected as the first characteristic, it may be identified that the electronic device is not in the submergence state, and if the electrical characteristic between the plurality of terminals 181 is detected as the second characteristic, it may be identified that the electronic device is in the submergence state.

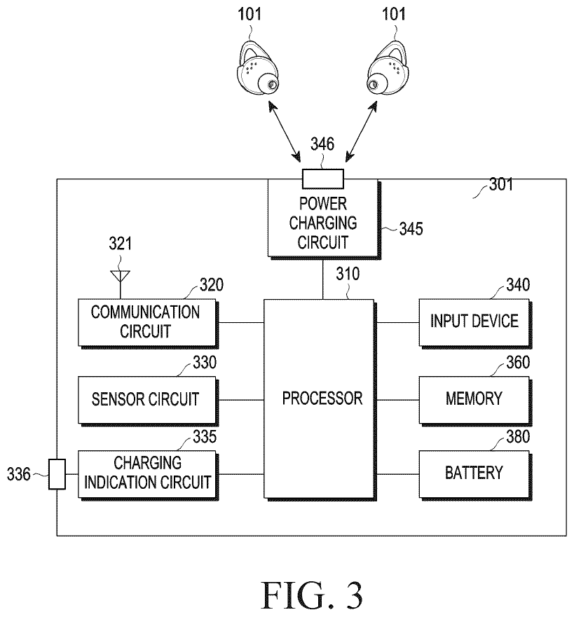

FIG. 3 is a block diagram illustrating a charger 301 electrically connected to an electronic device 101 according to various embodiments. According to various embodiments, the charger 301 may be the first external electronic device 104 of FIG. 1 and may be a case device for storing the electronic device 101 of FIG. 1. The charger 301 may include a processor 310, an antenna 321, a communication circuit 320, a sensor circuit 330, a charging indication circuit 335, an input device 340, a power charging circuit 345, memory 360, and/or a battery 380.

The processor 310 may execute, e.g., software to control at least one other component (e.g., a hardware or software component) of the charger 301 connected to the processor 310, and may perform various data processing or computation. According to an embodiment, as at least part of the data processing or computation, the processor 310 may load a command or data received from another component (e.g., the sensor circuit 330 or communication circuit 320) onto a volatile memory 360, process the command or the data stored in the volatile memory, and store resulting data in a non-volatile memory.

The processor 310 may be configured to receive a signal indicating the submergence state of the electronic device 101 output from the power charging circuit 345 while the indication state of the charging indication circuit 335 is a first indication state, and output a control signal for switching the indication state of the charging indication circuit 335 from the first indication state to a second indication state to the charging indication circuit 335 based on the received signal.

The processor 310 may output a control signal for cutting off charging of the electronic device 101 through the power charging circuit 345 to the power charging circuit 345, based on the signal indicating the submergence state of the electronic device 101 output from the power charging circuit 345. When the power charging circuit 345 receives the control signal for cutting off the charging of the electronic device 101, the power charging circuit 345 may cut off the charging of the electronic device 101 through the charging terminal (e.g., the plurality of terminals 181 of FIG. 1) contacting the charging pin 346.

The communication circuit 320 and/or the antenna circuit 321 according to various embodiments may have a configuration corresponding to the communication circuit 110 and/or the antenna 111 of the electronic device 101 of FIG. 1, or may have a configuration corresponding to the communication module 1190 and/or the antenna module 1197 of FIG. 11, which is described below.

The sensor circuit 330 may measure a physical quantity or detect an operating state of the charger 301. The sensor circuit 330 may convert the measured or detected information into an electrical signal. The sensor circuit 330 may include, e.g., an acceleration sensor, a gyro sensor, a geomagnetic sensor, a magnetic sensor, a proximity sensor, a gesture sensor, a grip sensor, an optical sensor, and/or a biometric sensor. According to an embodiment, the sensor circuit 330 may detect whether one or more of the electronic devices 101 are positioned in the charger 301. According to an embodiment, the sensor circuit 330 may detect a case where the cover of the charger 301 is in the open state and a case where the cover of the charger 301 is in the closed state. According to an embodiment, the processor 310 may be electrically connected with the sensor circuit 330 and may receive a signal indicating the open state and the closed state of the cover from the sensor circuit 330. When the electronic device 101 is positioned in the charger 301 and the cover is changed from the closed state to the open state, the processor 310 may generate a signal for turning on the communication circuit (e.g., the communication circuit 110 of FIG. 1) of the electronic device 101, and when the electronic device 101 is positioned in the charger 301 and the cover is changed from the open state to the closed state, the processor 310 may generate a signal for turning off the communication circuit (e.g., the communication circuit 110 of FIG. 1) of the electronic device 101. According to an embodiment, if the cover of the sensor circuit 330 is in the open state, the processor 310 may be triggered to allow the electronic device 101 and the external electronic device (e.g., the second external electronic device 105 of FIG. 1) to enter a pairing mode.

The charging indication circuit 335 may display the charge level of the battery 380 and/or the battery (e.g., the battery 165 of FIG. 1) of the electronic device 101. The user may identify the charge amount of the battery 380 of the charger 301 or the charge amount of the battery (e.g., the battery 165 of FIG. 1) of the electronic device 101 through the LED 336 on the surface of the charger 301. The charging indication circuit 335 may be implemented as an LED 336 or a display.

The input device 340 may be configured to generate various input signals necessary for operating the charger 301. The input device 340 may include a touch pad, a touch panel, or a button. The touch pad may recognize touch inputs in at least one of capacitive, resistive, infrared, or ultrasonic methods. If a capacitive touch pad is provided, physical contact or proximity recognition may be possible. The touch pad may further include a tactile layer. The touch pad including the tactile layer may provide a tactile response to the user. The button may include, e.g., a physical button or an optical key.

The power charging circuit 345 may manage power supplied from the charger 301 to the electronic device 101. For example, the power charging circuit 345 may be implemented as at least part of a power management integrated circuit (PMIC). In an embodiment, the power charging circuit 345 may wirelessly or wiredly provide power of the battery 380 to the electronic device 101 through the charging pin 346 or the antenna 321 under the control of the processor 310. The charging pin 346 may be visually exposed to the outside from the charger 301, and may contact and electrically connect to the plurality of terminals 181 of the electronic device 101 as the electronic device 101 is positioned inside the charger 301. For example, the charging pin 346 may be a POGO pin that may be inserted into the inside through a spring and an elastic body.

The power charging circuit 345 may be configured to output a signal indicating the submergence state of the electronic device 101 based on electrical characteristics between the charging terminals in the state of being electrically connected to the charging terminal (e.g., the plurality of terminals 181 of FIG. 1) of the electronic device 101. In an embodiment, the power charging circuit 345 may detect the electrical characteristic between the charging terminals by measuring the resistance between the charging terminals in the state of being electrically connected to the charging terminal through the charging pin 346.

The memory 360 may store various data used by at least one component (e.g., the processor 310 or the sensor circuit 330) of the charger 301. The various data may include, for example, software and input data or output data for a command related thereto. The memory 360 may include a volatile memory or a non-volatile memory.

The memory 360 according to an embodiment may store a resistance value between the plurality of terminals 181 that varies depending on the state (the first state or the second state) of the switching circuit 180 when the power charging circuit 345 is electrically connected to the electronic device 101, or may store the submergence state of the electronic device 101 identified using the measured resistance value.

The battery 380 may supply power to at least one component of the charger 301 and/or to the electronic device 101. According to an embodiment, the battery 380 may include, for example, a primary cell which is not rechargeable, a secondary cell which is rechargeable, or a fuel cell.

According to various embodiments, the electronic device 101 may identify at least one of first Bluetooth address information, second Bluetooth address information, or identification information about the charger 301 stored in at least one of the memory 360, the NFC tag, the RFID tag, the MST device, the QR code, or the barcode from the charger 301 through a communication circuit (e.g., the communication circuit 110 of FIG. 1).

According to various embodiments, the charger 301 may further include various modules depending on the form in which it is provided. There are many variations according to the convergence trend of digital devices, so it is not possible to list them all, but components equivalent to the above-mentioned components may be further included in the charger 301. Further, it is apparent that in the charger 301 according to an embodiment, specific components may be excluded from the above components or replaced with other components according to the form in which it is provided. This will be easily understood by those of ordinary skill in the art.

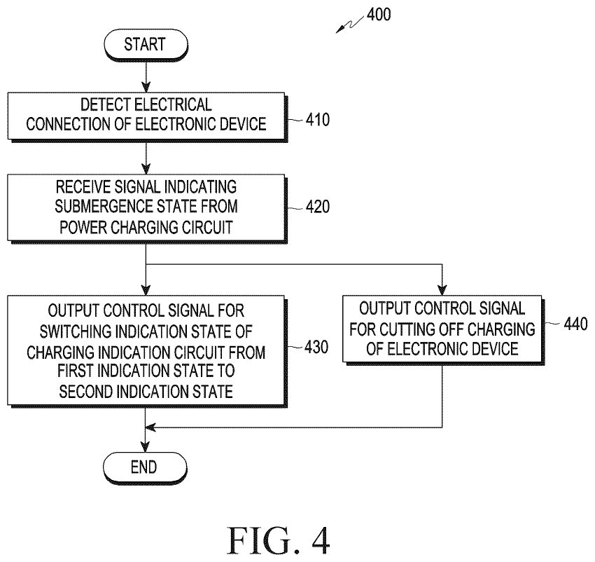

FIG. 4 is a flowchart 400 illustrating operations of a charger 301 according to various embodiments. According to various embodiments, the charger (e.g., the processor 310 of FIG. 3) may detect an electrical connection of the electronic device (e.g., the electronic device 101 of FIG. 1) in operation 410. For example, the power charging circuit 345 of the charger 301 may detect that the plurality of terminals 181 of the electronic device 101 contact the charging pin 346. The power charging circuit 345 may detect contact between the plurality of terminals 181 of the electronic device 101 by detecting resistance between the plurality of charging pins 346.

According to various embodiments, in operation 420, the charger (e.g., the processor 310 of FIG. 3) may receive a signal indicating the submergence state from the power charging circuit 345. Upon detecting the electrical connection of the electronic device 101, the power charging circuit 345 may measure the resistance value between the plurality of terminals 181 that varies depending on the state (e.g., the first state or the second state) of the switching circuit 180 and identify the submergence state of the electronic device 101 using the measured resistance value. The power charging circuit 345 may output a signal indicating the submergence state of the electronic device 101, which is identified using the measured resistance value, and the processor 310 may receive the signal indicating the submergence state from the power charging circuit 345.

According to various embodiments, in operation 430, the charger (e.g., the processor 310 of FIG. 3) may output a control signal for switching the indication state of the charging indication circuit 335 from the first indication state to the second indication state, based on the received signal indicating the submergence state. For example, the processor 310 may receive a signal indicating the submergence state from the power charging circuit 345, may output a control signal for switching the indication state of the charging indication circuit 335 from the first indication state to the second indication state when the submergence state of the electronic device 101 is detected, and may maintain the indication state of the charging indication circuit 335 as the first indication state when the submergence state of the electronic device 101 is not detected. Here, the first indication state may be a state indicating that the charger 301 normally charges the electronic device 101, and the second indication state may be a state indicating that the electronic device 101 is submerged. When the charging indication circuit 335 receives the control signal for switching the indication state from the first indication state to the second indication state, the charging indication circuit 335 may switch the indication state through the LED 336 or the display (not shown) from the first indication state to the second indication state.

According to various embodiments, in operation 440, the charger (e.g., the processor 310 of FIG. 3) may output a control signal for cutting off charging of the electronic device 101, based on the received signal indicating the submergence state. The processor 310 may output the control signal for cutting off charging of the electronic device 101 through the charging pin 346 and the plurality of terminals 181 to the power charging circuit 345. The processor 310 may receive the signal indicating the submergence state from the power charging circuit 345, may output the control signal for cutting off the charging of the electronic device 101 in the state in which submergence of the electronic device 101 is detected, and may maintain the charging of the electronic device 101 in the state in which submergence of the electronic device 101 is not detected. When the control signal for cutting off the charging of the electronic device 101 is received, the power charging circuit 345 may cut off the charging of the electronic device 101 through the charging pin 346 and the plurality of terminals 181.

In an embodiment, the charger (e.g., the processor 310 of FIG. 3) may sequentially execute operation 430 and operation 440, and in another embodiment, the charger (e.g., the processor 310 of FIG. 3) may execute operation 430 and operation 440 in the reverse order, i.e., execute operation 430 after operation 440. In another embodiment, the charger (e.g., the processor 310 of FIG. 3) may execute operations 430 and 440 in parallel, e.g., simultaneously execute operations 430 and 440.

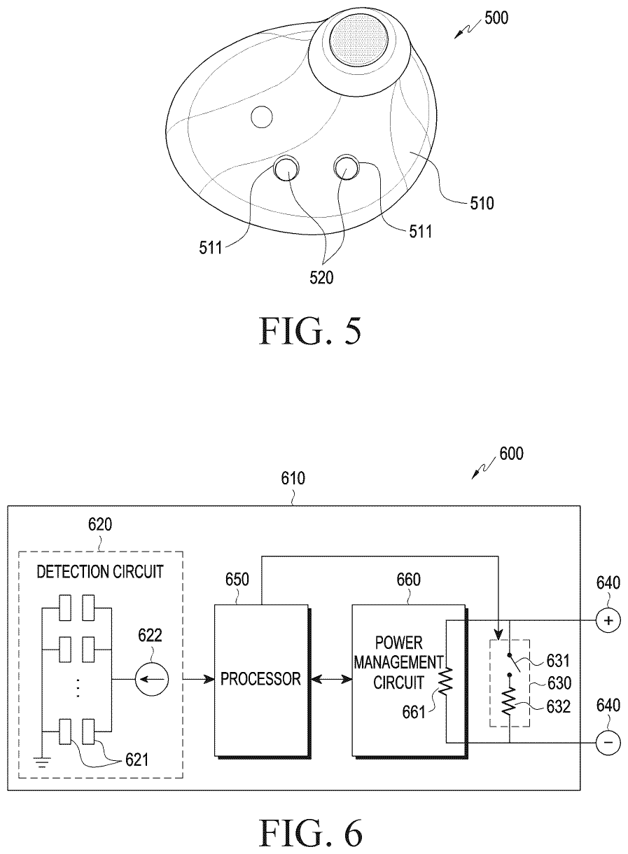

FIG. 5 illustrates an electronic device 500 for describing a housing 510 and a terminal 520 of the electronic device 500 according to various embodiments. According to various embodiments, the housing 510 of the electronic device 500 (e.g., the electronic device 101 of FIG. 1) may include the circuits, modules, and/or devices described above. In an embodiment, the circuit may be disposed on a printed board assembly (PBA), and the PBA may be disposed inside the housing 510.

The plurality of terminals 520 (e.g., the plurality of terminals 181 in FIG. 1) of the electronic device 500 may be visually exposed to the outside through the plurality of openings 511 formed in the housing 510. The housing 510 may have a plurality of openings 511 through which the inside communicates with the outside, and the plurality of terminals 520 may be exposed to the outside of the housing 510 through the plurality of openings 511, respectively. Here, the meaning that the plurality of terminals 520 are exposed to the outside of the housing 510 may encompass an embodiment in which the plurality of terminals 520 protrude to the outside of the housing 510, an embodiment in which the plurality of terminals 520 are positioned inside the housing 510, and an embodiment in which the plurality of terminals 520 are covered by a separate cover and may include all embodiments in which the plurality of terminals 520 may contact the charging pin 346 of the charger 301 positioned outside the housing 510.

FIG. 6 is a block diagram illustrating an electronic device 600 for describing signal transfer according to various embodiments. According to various embodiments, an electronic device 600 (e.g., the electronic device 101 of FIG. 1) may include a housing 610 (the housing 510 of FIG. 5), a detection circuit 620 (the detection circuit 130 of FIG. 1), a switching circuit 630 (the switching circuit 180 of FIG. 1), a plurality of terminals 640 (the plurality of terminals 181 of FIG. 1 and the plurality of terminals 520 of FIG. 5), a processor 650 (the processor 190 of FIG. 1), and a power management circuit 660 (the power management circuit 160 of FIG. 1).

The detection circuit 620 may include at least one detection pin 621 for detecting a condition associated with submergence and a current source 622 electrically connected to the at least one detection pin 621. One or more detection pins 621 may be provided, and the condition associated with submergence may be detected at each of the disposed positions. When the at least one detection pin 621 is submerged, a closed circuit connected to the current source 622 and the at least one detection pin 621 may be formed by moisture. The detection circuit 620 may measure the voltage value or the resistance value of the at least one detection pin 621 in the state in which the current source 622 supplying current to the at least one detection pin 621 is connected to the at least one detection pin 621, and may detect moisture based on the measured voltage value or resistance value. The current source 622 may be a constant current source that supplies current to at least one electrically connected detection pin 621 and, e.g., supplies constant current. Additionally, the detection circuit 620 may be provided with a current sensor (not shown) for measuring a current or a voltage sensor (not shown) for measuring a voltage.

In an embodiment, the at least one detection pin 621 may be connected in parallel with the current source 622 and may be configured of resistors having different resistance values (impedances), and thus total resistance values by all combinations measured by moisture may be different values. In other words, when at least one detection pin 621 is connected by moisture, the position where moisture is introduced may be identified by distinguishing the connected detection pin 621.

In another embodiment, the detection circuit 620 may include a voltage supply unit (not shown) for supplying a specific voltage to the at least one detection pin 621 and a reference resistor (not shown) connected to the voltage supply unit (not shown) in series with the at least one detection pin 621. Further, a voltage sensor (not shown) for measuring a voltage between the reference resistance and the at least one detection pin 621 may be further provided to detect the at least one detection pin 621 to which a voltage is applied by moisture.

The switching circuit 630 may be connected in parallel between the plurality of terminals 640. The state of the switching circuit 630 may be switched between the first state and the second state by a switching operation. The electrical characteristic between the plurality of terminals 640 while the switching circuit 630 is in the first state and the electrical characteristic between the plurality of terminals 640 while the switching circuit 630 is in the second state may be different from each other. In an embodiment, the resistance value of the first characteristic which is an electrical characteristic between the plurality of terminals 640 while the state of the switching circuit 630 is the first state may differ from the resistance value of the second characteristic which is an electrical characteristic between the plurality of terminals 640 while the state of the switching circuit 630 is the second state.

In an embodiment, the switching circuit 630 may include a switch 631 for controlling an opening/closing operation based on reception of a control signal and a switching resistor 632 connected in series to the switch 631. The switching circuit 630 may include the switch 631 and the switching resistor 632 connected in series with each other, and the switching resistor 632 may be connected in parallel to the plurality of terminals 640 or may be cut off from the electrical connection with the plurality of terminals 640 by an opening/closing operation of the switch 631.

In an embodiment, the first state of the switching circuit 630 may be a state in which the switch 631 is controlled to be turned off so that the electrical connection between the switching resistor 632 and the plurality of terminals 640 is cut off, and the second state of the switching circuit 630 may be a state in which the switch 631 is controlled to be turned on so that the switching resistor 632 is electrically connected to the plurality of terminals 640. Accordingly, the resistance value of the first characteristic, which is an electrical characteristic between the plurality of terminals 640 while the switching circuit 630 is in the first state, may be different from the resistance value of the second characteristic, which is an electrical characteristic between the plurality of terminals 640 while the switching circuit 630 is in the second state in which the switching resistor 632 is connected in parallel with the plurality of terminals 640, and may be, e.g., relatively large. In another embodiment, when the switching circuit 630 is in the first state, the switch 631 may be controlled to be turned on and may be closed, and when the switching circuit 630 is in the second state, the switch 631 may be controlled to be turned off and may be opened.

The plurality of terminals 640 may be connected to each other with the internal resistor 661 positioned therebetween, and the resistance between the plurality of terminals 640 may be measured as the resistance value of the internal resistor 661 having a specific resistance value. For example, in a state in which the switch 631 of the switching circuit 630 is controlled to be turned off so that the switching resistor 632 is cut off from electrical connection with the plurality of terminals 640, the resistance between the plurality of terminals 640 may be the resistance value of the internal resistor 661 having a specific resistance value.

The processor 650 may be operatively connected to the detection circuit 620 and the switching circuit 630, may receive a signal output from the detection circuit 620, and may output or receive a signal to/from the power management circuit 660 to be described below.

In an embodiment, the plurality of terminals 640 may be electrically connected to the power management circuit 660, and the internal resistor 661 between the plurality of terminals 640 may be a resistance included in the power management circuit 660. In other words, the power management circuit 660 may be electrically connected to the plurality of terminals 640 in parallel with the switching circuit 630, and the plurality of terminals 640 may be electrically connected to the power management circuit 660 and the switching circuit 630 connected in parallel with each other.

The plurality of terminals 640 may be exposed to the outside through the plurality of openings 511 of the housing and may contact other devices outside the housing. For example, the plurality of terminals 640 may contact a device such as a multimeter or an ohm meter, so that the resistance value between the plurality of terminals 640 may be measured, and accordingly, the state of the switching circuit 630 may be identified without disassembling the electronic device 600.

The plurality of terminals 640 may be charging terminals connected to an external charger (e.g., the charger 301 of FIG. 3) to receive power from the outside. For example, when the electronic device 600 is seated inside the external charger (e.g., the charger 301 of FIG. 3), the plurality of terminals 640 may be charging terminals electrically connected to the charging pin (e.g., the charging pin 346 of FIG. 3) of the external charger (e.g., the charger 301 of FIG. 3). In another embodiment, the plurality of terminals 640 may be some of micro pins or USB pins provided in the electronic device 600. The plurality of terminals 640 may be electrically connected to the power management circuit 660 to charge the battery (e.g., the battery 165 of FIG. 1) mounted on the electronic device 600 with power applied from an external charger (e.g., the charger 301 of FIG. 3).

In another embodiment, the detection circuit 620 may be configured to output a switch control signal for switching the state of the switching circuit 630 when the submergence is detected. For example, when submergence is detected, the detection circuit 620 may directly provide a switch control signal to the switching circuit 630, and in this case, the state of the switching circuit 630 may be switched without intervention of the processor 650.

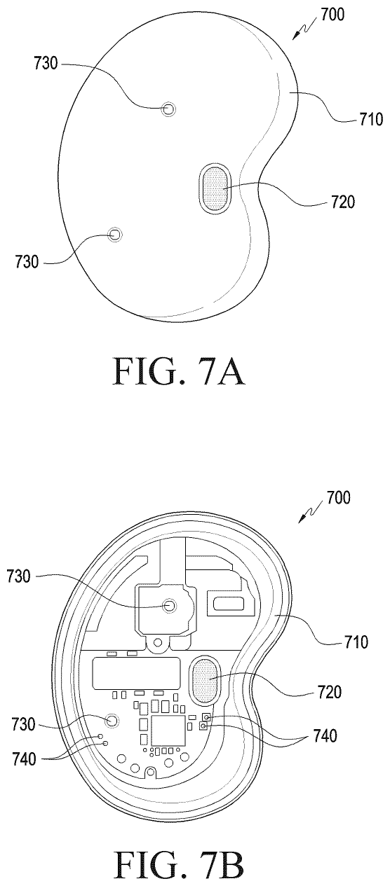

FIG. 7A illustrates an electronic device for describing an arrangement of penetration holes and detection pins of an electronic device according to various embodiments, and FIG. 7B illustrates a disassembled electronic device for describing an arrangement of penetration holes and detection pins of an electronic device according to various embodiments.

According to an embodiment, the electronic device 700 (e.g., the electronic device 101 of FIG. 1) may include at least one penetration hole 720 or 730 through which the inside of the housing 710 communicates with the outside. The at least one penetration hole 720 or 730 may be penetrated so that the housing 710 is completely open, but may be finely opened only in a partial area, or the at least one penetration hole 720 or 730 may be waterproofed for preventing moisture penetration.

According to an embodiment, the at least one penetration hole 720 or 730 may be a microphone hole 720 formed to receive a sound input through a microphone (e.g., the microphone 142 of FIG. 1) of an audio processing circuit (e.g., the audio processing circuit 140 of FIG. 1) positioned inside the housing 710 from the outside of the housing 710, a vent hole 730 formed such that the inside of the housing 710 communicates with the outside for venting, or a speaker hole (not shown) formed to output a sound through a speaker (e.g., the speaker 141 of FIG. 1) of an audio processing circuit (e.g., the audio processing circuit 140 of FIG. 1) positioned inside the housing 710.

According to an embodiment, the at least one detection pin 740 (e.g., the at least one detection pin 621 of FIG. 6) may be positioned inside the housing 710 and may be disposed at a position connected to the at least one penetration hole 720 or 730 or at a position within a preset range from the at least one penetration hole 720 or 730. In an embodiment, the at least one detection pin 740 may be positioned inside the housing 710 at a position in contact with or connected to the at least one penetration hole 720 or 730. In another embodiment, the at least one detection pin 740 may be disposed within a predetermined range from the at least one penetration hole 720 or 730 so as to be positioned inside the housing 710 at a position adjacent to the at least one penetration hole 720 or 730. Here, the preset range may be a range within a radius corresponding to a specific distance from the at least one penetration hole 720 or 730.

When the electronic device 700 is submerged in water, moisture may be introduced into the housing 710 through the at least one penetration hole 720 or 730 formed in the housing 710. In other words, when the electronic device 700 is submerged, water may be introduced through the at least one penetration hole 720 or 730 formed in the housing 710. Therefore, as the at least one detection pin 740 is disposed adjacent to the at least one penetration hole 720 or 730, submergence of the electronic device 700 may be quickly and accurately detected. Although the detection pins 740 are illustrated as being located on one side of the at least one penetration hole 720 or 730, the detection pins 740 may be disposed on opposite sides of the at least one penetration hole 720 or 730.

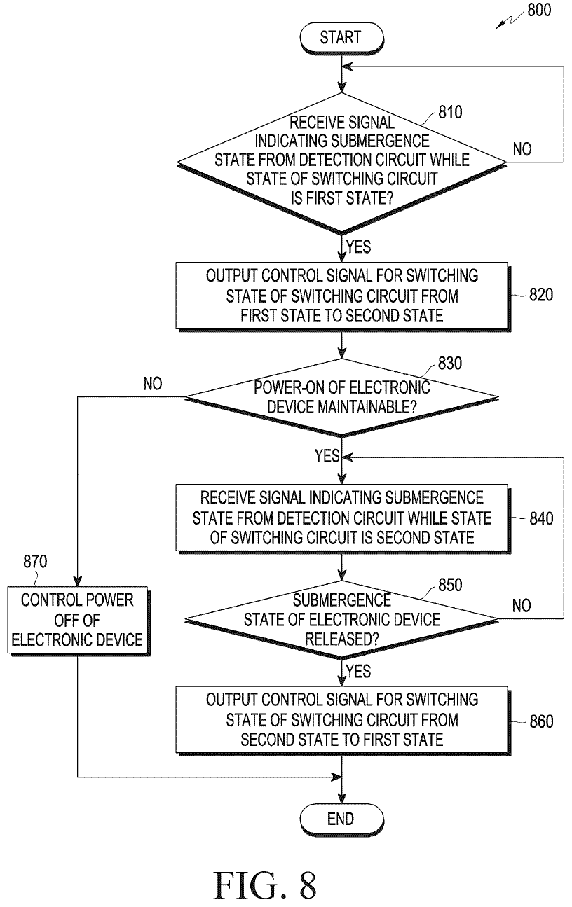

FIG. 8 is a flowchart 800 illustrating operations of an electronic device according to various embodiments. According to various embodiments, in operation 810, while the state of the switching circuit (e.g., the switching circuit 180 of FIG. 1) electrically connected to the plurality of terminals (e.g., the plurality of terminals 181 of FIG. 1) exposed to the outside through the plurality of openings (e.g., the plurality of openings 511 of FIG. 5) formed in the housing is the first state, the electronic device (e.g., the processor 190 of FIG. 1) may receive a signal indicating the submergence state output from the detection circuit (e.g., the detection circuit 130 of FIG. 1) based on satisfaction of the condition associated with the submergence state. The detection circuit may determine whether the condition associated with submergence is met at the plurality of detection pins, and output a signal indicating the submergence state based on the condition associated with submergence being met.

According to an embodiment, the electronic device may receive the signal indicating the submergence state output from the detection circuit while the state of the switching circuit electrically connected to the plurality of terminals exposed to the outside is the first state. Here, while the switching circuit is in the first state, the electrical characteristic between the plurality of terminals may be the first characteristic.

According to various embodiments, in operation 820, the electronic device (e.g., the electronic device 101 of FIG. 1) may output, to the switching circuit, a control signal for switching the state of the switching circuit from the first state to the second state, based on the signal received from the detection circuit. According to an embodiment, when the signal indicating the submergence state received from the detection circuit indicates that the electronic device is submerged, the electronic device may output, to the switching circuit, a control signal for switching the state of the switching circuit from the first state to the second state. Further, when the signal indicating the submergence state received from the detection circuit indicates that the electronic device is not submerged, the electronic device may not output a control signal for switching the state of the switching circuit.

According to an embodiment, the switching circuit may switch from the first state to the second state based on reception of the control signal for switching the state of the switching circuit. In exemplary embodiments, while the switching circuit is in the second state, the electrical characteristic between the plurality of terminals may be a second characteristic different from the first characteristic. Accordingly, it is possible to identify the state of the switching circuit and the submergence of the electronic device through the electrical characteristic between the plurality of terminals measured by the charging pin of the charger contacting the plurality of terminals or the measuring device measuring the resistance value.

According to an embodiment, in operation 820, the electronic device (e.g., the electronic device 101 of FIG. 1) may output, to the switching circuit, a control signal for switching the state of the switching circuit from the first state to the second state, regardless of whether the power-on state of the electronic device described below is maintainable. Further, according to an embodiment, the switching circuit may switch from the first state to the second state based on reception of a control signal for switching the state of the switching circuit, regardless of whether the power-on state of the electronic device described below is maintainable. In other words, even if the electronic device (e.g., the electronic device 101 of FIG. 1) may not maintain the power-on state due to submergence, the state of the switching circuit may be switched from the first state to the second state.

According to various embodiments, in operation 830, the electronic device (e.g., the electronic device 101 of FIG. 1) may identify whether the power-on state of the electronic device is maintainable, based on the signal received from the detection circuit. In an embodiment, when the signal indicating the submergence state received from the detection circuit indicates that the electronic device is submerged, the electronic device may identify whether the power-on state of the electronic device is maintainable. Whether the power-on state of the electronic device is maintainable may relate to whether an internal component such as a printed board assembly (PBA), a processor, a circuit, or a battery provided in the electronic device is normally operable. When the electronic device maintains the power-on state, the electronic device may identify whether the power-on state is maintainable based on the possibility of short circuit (short), current leakage, or corrosion in at least one component provided therein.

According to various embodiments, in operation 840, the electronic device (e.g., the electronic device 101 of FIG. 1) may receive the signal indicating the submergence state output from the detection circuit while the switching circuit is in the second state, based on the identification of whether the power-on state is maintainable.

In an embodiment, when it is possible to maintain the power-on state of the electronic device, the detection circuit may continuously determine whether the condition associated with submergence is met while the switching circuit is in the second state, and may output the signal indicating the submergence state based on the satisfaction of the condition associated with submergence. The electronic device may receive the signal indicating the submergence state output from the detection circuit while the switching circuit is in the second state.

According to various embodiments, in operation 870, when it is not possible to maintain the power-on state of the electronic device, the electronic device may control the electronic device to be powered off. In this case, in the state in which the electronic device is powered off, the state of the switching circuit may be maintained in the second state, and the electrical characteristic between the plurality of terminals may be maintained as the second characteristic.

According to various embodiments, in operation 850, the electronic device (e.g., the electronic device 101 of FIG. 1) may identify whether the signal indicating the submergence state received from the detection circuit indicates that the submergence state is released. In an embodiment, while the state of the switching circuit is the second state, the electronic device may continuously receive the signal indicating the submergence state received from the detection circuit, and when the received signal indicates the state in which the electronic device is no longer submerged, the electronic device may identify that the submergence state is released.

According to various embodiments, in operation 860, the electronic device (e.g., the electronic device 101 of FIG. 1) may output, to the switching circuit, a control signal for switching the state of the switching circuit from the second state to the first state, based on the signal indicating the submergence state received from the detection circuit. In an embodiment, when it is identified that the submergence is released based on the signal indicating the submergence state received from the detection circuit while the state of the switching circuit is the second state, the electronic device may output a control signal for switching the state of the switching circuit from the second state to the first state to the switching circuit.

When the switching circuit receives the control signal for switching from the second state to the first state from the electronic device, the switching circuit may switch the state from the second state to the first state. Accordingly, the electrical characteristic between the plurality of terminals may be restored from the second characteristic to the first characteristic.

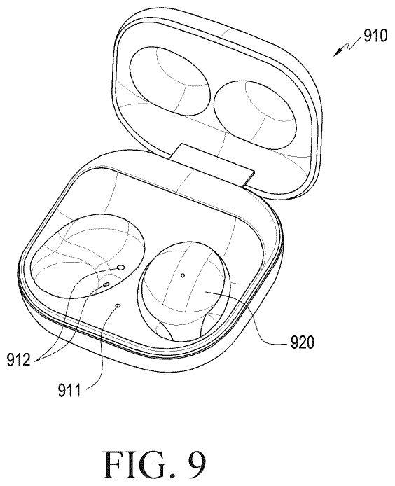

FIG. 9 illustrates a charger 910 (e.g., the charger 301 of FIG. 3) in a state of being electrically connected to an electronic device 920 according to various embodiments. The charger 910 according to various embodiments may be provided with a space in which the electronic device 920 is seated, and may be electrically connected to the electronic device 920 as the electronic device 920 is seated therein.

According to various embodiments, the charger 910 may be provided with an LED 911 that emits light when operating. In an embodiment, the LED 911 (e.g., the LED 336 of FIG. 3) may be operatively connected to a charging indication circuit (e.g., the charging indication circuit 335 of FIG. 3) of the charger 910, and the charging indication circuit may control the LED 911 based on the indication state.

In an embodiment, the charging indication circuit may control the LED 911 in the first indication state or the second indication state. For example, in the first indication state and the second indication state controlled by the charging indication circuit, the color of the light emitted from the LED 911 may be different, and/or the period in which the LED 911 flashes may be different.

In another embodiment, the charger 910 may include a separate display device such as a display in addition to the LED 911, and the charging indication circuit may control the display device based on the indication state.

A charging pin 912 may be formed in the charger 910 according to various embodiments. The charging pin 912 may extend through a through hole formed in the charger 910, and one end portion of the charging pin 912 may be positioned inside the charger 910 to be electrically connected to a power charging circuit (e.g., the power charging circuit 345 of FIG. 3), and the other end portion of the charging pin 912 may be positioned outside the charger 910 to be electrically connected to a charging terminal (e.g., the plurality of terminals 181 of FIG. 1) of the electronic device 920.

In an embodiment, the charging pin 912 may be formed to protrude outward of the charger 910 by an elastic force of a spring or an elastic body, and may be pressed as the electronic device 920 is seated on the charger 910. With the electronic device 920 seated on the charger 910, the charging pin 912 may contact the charging terminal (e.g., the plurality of terminals 181 of FIG. 1) of the electronic device 920 by an elastic force and may be electrically connected thereto.

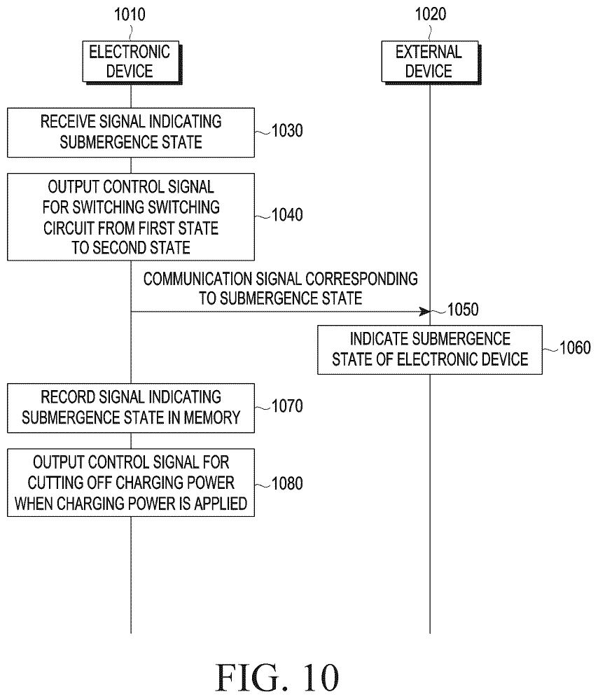

FIG. 10 is a signal diagram of signal transfer between an electronic device 1010 and an external device 1020 according to various embodiments. According to an embodiment, the electronic device 1010 (e.g., the processor 190 of FIG. 1) may receive a signal indicating the submergence state of the electronic device 1010 from the detection circuit (e.g., the detection circuit 130 of FIG. 1) in operation 1030.

According to an embodiment, the electronic device 1010 (e.g., the processor 190 of FIG. 1) may output a control signal for switching the switching circuit (e.g., the switching circuit 180 of FIG. 1) from the first state to the second state in operation 1040. When the switching circuit receives the control signal, the switching circuit may switch the state from the first state in which the electrical characteristic between the plurality of terminals (e.g., the plurality of terminals 181 of FIG. 1) are the first characteristic to the second state in which the electrical characteristic between the plurality of terminals are the second characteristic different from the first characteristic.

According to an embodiment, the electronic device 1010 (e.g., the processor 190 of FIG. 1) may output a control signal for transmitting a communication signal corresponding to the signal indicating the submergence state of the electronic device 1010 received from the detection circuit (e.g., the detection circuit 130 of FIG. 1) to the external device 1020 in communication with the electronic device 1010, to the communication circuit (e.g., the communication circuit 110 of FIG. 1) in operation 1050. The communication circuit may receive the control signal output to transmit the communication signal corresponding to the signal indicating the submergence state, and transmit the communication signal to the external device 1020.

According to various embodiments, the external device 1020 (e.g., the electronic device 1101 of FIG. 11) may receive the communication signal output from the electronic device 1010 through the communication circuit through the communication module (e.g., the communication module 1190 of FIG. 11) in operation 1060. The external device 1020 may display the submergence state of the electronic device 1010 on a display device (e.g., the display module 1160 of FIG. 11), based on the received communication signal.

According to various embodiments, the electronic device 1010 (e.g., the processor 190 of FIG. 1) may store a record corresponding to the signal indicating the submergence state of the electronic device 1010 received from the detection circuit (e.g., the detection circuit 130 of FIG. 1) in the memory (e.g., the memory 150 of FIG. 1) in operation 1070.

Further, the electronic device 1010 (e.g., the processor 190 of FIG. 1), when wiredly or wirelessly connected with the external device 1020, may transmit the record stored in the memory to the external device 1020 through the communication circuit.

According to various embodiments, in operation 1080, the electronic device 1010 (e.g., the processor 190 of FIG. 1), upon application of charging power from the charger (e.g., the charger 910 of FIG. 9), may output a control signal for cutting off the charging power based on the signal indicating the submergence state of the electronic device 1010 received from the detection circuit (e.g., the detection circuit 130 of FIG. 1). When the electronic device 1010 receives the signal indicating the submergence state of the electronic device 1010 from the detection circuit, the electronic device 1010 may output a control signal for cutting off charging power input through the charging terminal (e.g., the plurality of terminals 181 of FIG. 1).

When the power management circuit (e.g., the power management circuit 160 of FIG. 1) receives the control signal for cutting off charging power, the power management circuit (e.g., the power management circuit 160 of FIG. 1) may cut off charging power applied through the charging terminal (e.g., the plurality of terminals 181 of FIG. 1).

FIG. 11 is a block diagram illustrating an electronic device 1101 (e.g., the external device 1020 or the electronic device 1010 of FIG. 10) in a network environment according to various embodiments. Referring to FIG. 11, the electronic device 1101 in the network environment 1100 may communicate with an electronic device 1102 via a first network 1198 (e.g., a short-range wireless communication network), or an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor circuit 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In an embodiment, at least one (e.g., the connecting terminal 1178) of the components may be omitted from the electronic device 1101, or one or more other components may be added in the electronic device 101. According to an embodiment, some (e.g., the sensor circuit 1176, the camera module 1180, or the antenna module 1197) of the components may be integrated into a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor circuit 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 1101 includes the main processor 1121 and the auxiliary processor 1123, the auxiliary processor 1123 may be configured to use lower power than the main processor 1121 or to be specified for a designated function. The auxiliary processor 1123 may be implemented as separate from, or as part of the main processor 1121.

The auxiliary processor 1123 may control at least some of functions or states related to at least one component (e.g., the display module 1160, the sensor circuit 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 123. According to an embodiment, the auxiliary processor 1123 (e.g., the neural processing unit) may include a hardware structure specified for artificial intelligence model processing. The artificial intelligence model may be generated via machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor circuit 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by other component (e.g., the processor 1120) of the electronic device 1101, from the outside (e.g., a user) of the electronic device 1101. The input module 1150 may include, for example, a microphone, a mouse, a keyboard, keys (e.g., buttons), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display 1160 may include, for example, a display, a hologram device, or a projector and control circuitry to control a corresponding one of the display, hologram device, and projector. According to an embodiment, the display 1160 may include a touch sensor configured to detect a touch, or a pressure sensor configured to measure the intensity of a force generated by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor circuit 1176 may detect an operational state (e.g., power or temperature) of the electronic device 1101 or an environmental state (e.g., a state of a user) external to the electronic device 101, and then generate an electrical signal or data value corresponding to the detected state. According to an embodiment, the sensor circuit 1176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, a HDMI connector, a USB connector, a SD card connector, or an audio connector (e.g., a headphone connector).

The haptic module 1179 may convert an electrical signal into a mechanical stimulus (e.g., a vibration or motion) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device 1104 via a first network 1198 (e.g., a short-range communication network, such as Bluetooth™, wireless-fidelity (Wi-Fi) direct, or infrared data association (IrDA)) or a second network 1199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 1192 may identify or authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device). According to an embodiment, the antenna module 1197 may include one antenna including a radiator formed of a conductor or conductive pattern formed on a substrate (e.g., a printed circuit board (PCB)). According to an embodiment, the antenna module 1197 may include a plurality of antennas (e.g., an antenna array). In this case, at least one antenna appropriate for a communication scheme used in a communication network, such as the first network 1198 or the second network 1199, may be selected from the plurality of antennas by, e.g., the communication module 1190. The signal or the power may then be transmitted or received between the communication module 1190 and the external electronic device via the selected at least one antenna. According to an embodiment, other parts (e.g., radio frequency integrated circuit (RFIC)) than the radiator may be further formed as part of the antenna module 1197.

According to various embodiments, the antenna module 1197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 1101 and the external electronic device 1104 via the server 1108 coupled with the second network 1199. The external electronic devices 1102 or 1104 each may be a device of the same or a different type from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an Internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

According to various embodiments, an electronic device may include a housing, a detection circuit disposed inside the housing, and configured to output a signal indicating a flooding state based on a condition associated with flooding being satisfied, a plurality of terminals exposed to an outside through a plurality of openings formed in the housing, a switching circuit electrically connected to the plurality of terminals, and a processor operatively connected with the detection circuit and the switching circuit. The processor may be configured to receive the signal output from the detection circuit while a state of the switching circuit is a first state and output, to the switching circuit, a control signal for switching the state of the switching circuit from the first state to a second state based on the received signal. The switching circuit may be configured to switch from the first state to the second state based on reception of the control signal.

According to various embodiments, the housing may have at least one penetration hole through which an inside communicates with an outside. The detection circuit may include at least one detection pin configured to detect the condition associated with the flooding. The at least one detection pin may be disposed at a position connected with the at least one penetration hole inside the housing or a position within a preset range from the at least one penetration hole.

According to various embodiments, the detection circuit may include at least one detection pin detecting a condition associated with the flooding and a current source supplying a current to the at least one detection pin, wherein the at least one detection pin is electrically connected in parallel to the current source. The detection circuit may be configured to measure at least one of a resistance value or a voltage value corresponding to the at least one detection pin and detect an abnormality in the electronic device based on at least one of the measured resistance value or the measured voltage value.

According to various embodiments, the switching circuit may include a switch configured to be controlled to be opened/closed based on the reception of the control signal and a switching resistor connected in series to the switch. A first characteristic which is an electrical characteristic between the plurality of terminals while the state of the switching circuit is the first state may be different from a second characteristic which is an electrical characteristic between the plurality of terminals while the state of the switching circuit is the second state.

According to various embodiments, the processor may be configured to identify whether a power-on state of the electronic device can be maintained based on the received signal, receive the signal indicating the flooding state output from the detection circuit while the state of the switching circuit is the second state based on identifying whether the power-on state can be maintained, and output, to the switching circuit, a control signal for switching the state of the switching circuit from the second state to the first state based on the received signal.

According to various embodiments, the electronic device may further include a power management circuit electrically connected, in parallel with the switching circuit, to the plurality of terminals. The plurality of terminals may be charging terminals connected to an external charger to receive power from an outside.

According to various embodiments, the processor may be configured to output, to the power management circuit, a control signal for cutting off charging power applied to the plurality of terminals from the external charger based on the received signal.

According to various embodiments, the electronic device may further include a communication circuit operatively connected with the processor. The processor may be configured to output, to the communication circuit, a control signal for transmitting a communication signal corresponding to the received signal to an external device connected with the electronic device, based on the received signal.

According to various embodiments, the electronic device may further include memory operatively connected with the processor. The processor may be configured to store a record corresponding to the received signal in the memory, based on the received signal.

According to various embodiments, an operation method of an electronic device may include receiving a signal indicating a flooding state output from a detection circuit based on a condition associated with flooding being satisfied while a state of a switching circuit electrically connected to a plurality of terminals exposed to an outside through a plurality of openings formed in a housing is a first state and outputting, to the switching circuit, a control signal for switching the state of the switching circuit from the first state to a second state based on the received signal. The switching circuit may be configured to switch from the first state to the second state based on reception of the control signal.

According to various embodiments, the housing may have at least one penetration hole through which an inside communicates with an outside. The detection circuit may include at least one detection pin configured to detect the condition associated with the flooding. The at least one detection pin may be disposed at a position connected with the at least one penetration hole inside the housing or a position within a preset range from the at least one penetration hole.

According to various embodiments, the detection circuit may include at least one detection pin configured to detect a condition associated with the flooding and a current source configured to supply a current to the at least one detection pin, wherein the at least one detection pin is electrically connected in parallel to the current source. The detection circuit may be operated to measure at least one of a resistance value or a voltage value corresponding to the at least one detection pin and detect an abnormality in the electronic device based on at least one of the measured resistance value or voltage value.

According to various embodiments, the switching circuit may include a switch configured to be controlled to be opened/closed based on the reception of the control signal and a switching resistor connected in series to the switch. A first characteristic which is an electrical characteristic between the plurality of terminals while the state of the switching circuit is the first state may be different from a second characteristic which is an electrical characteristic between the plurality of terminals while the state of the switching circuit is the second state.

According to various embodiments, the method may further include identifying whether a power-on state of the electronic device can be maintained based on the received signal, receiving the signal indicating the flooding state output from the detection circuit while the state of the switching circuit is the second state based on identifying whether the power-on state can be maintained, and outputting, to the switching circuit, a control signal for switching the state of the switching circuit from the second state to the first state based on the received signal.

According to various embodiments, the plurality of terminals may be charging terminals electrically connected in parallel with the switching circuit to a power management circuit, and connected to an external charger to receive power from an outside.

According to various embodiments, the method may further include outputting, to the power management circuit, a control signal for cutting off charging power applied to the plurality of terminals from the external charger based on the received signal.

According to various embodiments, the method may further include outputting, to a communication circuit, a control signal for transmitting a communication signal corresponding to the received signal to an external device connected with the electronic device, based on the received signal.

According to various embodiments, the method may further include storing a record corresponding to the received signal in the memory based on the received signal.

According to various embodiments, a charger may include a power charging circuit configured to output a signal indicating a flooding state of an electronic device based on an electrical characteristic between a plurality of terminals in a state electrically connected to the plurality of terminals of the electronic device, a charging indication circuit, and a processor operatively connected with the power charging circuit and the charging indication circuit. The processor may be configured to receive the signal output from the power charging circuit while an indication state of the charging indication circuit is a first indication state and output, to the charging indication circuit, a control signal for switching the indication state of the charging indication circuit from the first indication state to a second indication state based on the received signal. The charging indication circuit may be configured to switch from the first indication state to the second indication state based on the reception of the control signal.

According to various embodiments, the processor may be configured to output, to the power charging circuit, a control signal for cutting off charging of the electronic device through the power charging circuit, based on the received signal.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a PDA (personal digital assistant), a portable multimedia player (PMP), an MP3 player, a mobile medical device, a camera, or a wearable device. The wearable device may include at least one of an accessory-type device (e.g., a watch, a ring, a bracelet, an anklet, a necklace, glasses, contact lenses, or a head-mounted device (HMD)), a fabric- or clothes-integrated device (e.g., electronic clothes), a body attaching-type device (e.g., a skin pad or tattoo), or a body implantable device. In some embodiments, examples of the smart home appliance may include at least one of a television, a digital video disk (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™, Apple TV™, or Google TV™), a gaming console (Xbox™, PlayStation™), an electronic dictionary, an electronic key, a camcorder, or an electronic picture frame.

According to an embodiment of the present disclosure, examples of the electronic device may include at least one of various medical devices (e.g., diverse portable medical measuring devices (a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs) of financial organizations, point of sales (POS) devices of stores, or Internet of things devices (e.g., a bulb, various sensors, a sprinkler, a fire alarm, a thermostat, a street light, a toaster, fitness equipment, a hot water tank, a heater, or a boiler). According to various embodiments of the disclosure, examples of the electronic device may at least one of part of furniture or building/structure, an electronic board, an electronic signature receiving device, a projector, or various measurement devices (e.g., devices for measuring water, electricity, gas, or electromagnetic waves). According to embodiments of the present invention, the electronic device may be flexible or may be a combination of the above-enumerated electronic devices. According to an embodiment of the disclosure, the electronic devices are not limited to those described above. As used herein, the term “user” may denote a human or another device (e.g., an artificial intelligent electronic device) using the electronic device.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
a housing;
a detection circuit disposed inside the housing, and configured to output a signal indicating a flooding state based on a condition associated with flooding being satisfied;
a plurality of terminals exposed to an outside of the housing through a plurality of openings formed in the housing;
a switching circuit electrically connected to the plurality of terminals; and
at least one processor including processing circuitry; and
memory comprising one or more storage media storing instructions that, when executed by the at least one processor individually or collectively, cause the electronic device to:
receive the signal output from the detection circuit while a state of the switching circuit is a first state; and
output, to the switching circuit, a control signal for switching the state of the switching circuit from the first state to a second state based on the received signal, and
wherein the switching circuit is configured to switch from the first state to the second state based on reception of the control signal.

2. The electronic device of claim 1, wherein the housing has at least one penetration hole through which an inside of the housing communicates with the outside of the housing,
wherein the detection circuit includes at least one detection pin configured to detect the condition associated with the flooding, and
wherein the at least one detection pin is disposed in one of a position connected with the at least one penetration hole inside the housing and a position within a preset range from the at least one penetration hole.

3. The electronic device of claim 1, wherein the detection circuit includes at least one detection pin configured to detect the condition associated with the flooding and a current source configured to supply a current to the at least one detection pin, wherein the at least one detection pin is electrically connected in parallel to the current source, and
wherein the detection circuit is configured to measure at least one of a resistance value or a voltage value corresponding to the at least one detection pin, and detect an abnormality in the electronic device based on at least one of the measured resistance value or the measured voltage value.

4. The electronic device of claim 1, wherein the switching circuit includes a switch configured to be controlled to be opened/closed based on the reception of the control signal and a switching resistor connected in series to the switch, and
wherein a first characteristic which is an electrical characteristic between the plurality of terminals while the state of the switching circuit is the first state, is different from a second characteristic, which is an electrical characteristic between the plurality of terminals while the state of the switching circuit is the second state.

5. The electronic device of claim 1, wherein the instructions, when executed by the at least one processor individually or collectively, cause the electronic device to:
identify whether a power-on state of the electronic device can be maintained based on the received signal;
receive the signal indicating the flooding state output from the detection circuit while the state of the switching circuit is the second state based on identifying whether the power-on state can be maintained; and
output, to the switching circuit, the control signal for switching the state of the switching circuit from the second state to the first state based on the received signal.

6. The electronic device of claim 1, further comprising a power management circuit electrically connected, in parallel with the switching circuit, to the plurality of terminals,
wherein the plurality of terminals are charging terminals connected to an external charger to receive power from the outside of the housing.

7. The electronic device of claim 6, wherein the instructions, when executed by the at least one processor individually or collectively, cause the electronic device to output, to the power management circuit, a control signal for cutting off charging power applied to the plurality of terminals from the external charger based on the received signal.

8. The electronic device of claim 1, further comprising a communication circuit,
wherein the instructions, when executed by the at least one processor individually or collectively, cause the electronic device to output, to the communication circuit, a control signal for transmitting a communication signal corresponding to the received signal to an external device connected with the electronic device, based on the received signal.

9. The electronic device of claim 1, wherein the instructions, when executed by the at least one processor individually or collectively, cause the electronic device to store a record corresponding to the received signal in the memory, based on the received signal.

10. An operation method of an electronic device, the operation method comprising:
receiving a signal indicating a flooding state from a detection circuit based on a condition associated with flooding being satisfied while a state of a switching circuit electrically connected to a plurality of terminals exposed to an outside of a housing of the electronic device through a plurality of openings formed in the housing is a first state; and
outputting, to the switching circuit, a control signal for switching the state of the switching circuit from the first state to a second state based on the received signal,
wherein the switching circuit is configured to switch from the first state to the second state based on reception of the control signal.

11. The operation method of claim 10, wherein the detection circuit includes at least one detection pin configured to detect the condition associated with the flooding and a current source configured to supply a current to the at least one detection pin, wherein the at least one detection pin is electrically connected in parallel to the current source, and
wherein the detection circuit is configured to measure at least one of a resistance value or a voltage value corresponding to the at least one detection pin and to detect an abnormality in the electronic device based on at least one of the measured resistance value or the voltage value.

12. The operation method of claim 10, wherein the switching circuit includes a switch configured to be controlled to be opened/closed based on the reception of the control signal and a switching resistor connected in series to the switch, and
wherein a first characteristic which is an electrical characteristic between the plurality of terminals while the state of the switching circuit is the first state is different from a second characteristic which is an electrical characteristic between the plurality of terminals while the state of the switching circuit is the second state.

13. The operation method of claim 10, further comprising:
identifying whether a power-on state of the electronic device can be maintained based on the received signal;
receiving the signal indicating the flooding state output from the detection circuit while the state of the switching circuit is the second state based on identifying whether the power-on state can be maintained; and
outputting, to the switching circuit, the control signal for switching the state of the switching circuit from the second state to the first state based on the received signal.

14. The operation method of claim 10, wherein the plurality of terminals are charging terminals electrically connected in parallel with the switching circuit to a power management circuit, and connected to an external charger to receive power from the outside of the housing, and
wherein the method further comprises outputting, to the power management circuit, a control signal for cutting off charging power applied to the plurality of terminals from the external charger based on the received signal.

15. The operation method of claim 10, further comprising outputting, to a communication circuit, a control signal for transmitting a communication signal corresponding to the received signal to an external device connected with the electronic device, based on the received signal.

16. An electronic device, comprising:
a housing;
a detection circuit disposed inside the housing, the detection circuit configured to detect a condition associated with flooding of the housing and responsively output a signal;
a plurality of terminals exposed to an outside of the housing through a plurality of openings formed in the housing; and
a switching circuit electrically connected to the plurality of terminals,
wherein the switching circuit is configured to switch from a first state to a second state based on the signal.

17. The electronic device of claim 16, wherein the detection circuit includes at least one detection pin configured to detect the condition associated with the flooding and a current source configured to supply a current to the at least one detection pin, wherein the at least one detection pin is electrically connected in parallel to the current source, and
wherein the detection circuit is configured to measure at least one of a resistance value and a voltage value corresponding to the at least one detection pin, and detect an abnormality in the electronic device based on at least one of the measured resistance value and the measured voltage value.

18. The electronic device of claim 1, wherein the switching circuit includes a switch configured to be controlled to be opened/closed based on a reception of the signal and a switching resistor connected in series to the switch, and
wherein a first characteristic which is an electrical characteristic between the plurality of terminals while the state of the switching circuit is the first state, is different from a second characteristic, which is an electrical characteristic between the plurality of terminals while the state of the switching circuit is the second state.
